(19) United States
(12) Patent Application Publication
(10) Pub. No.: US 2004/0022163 A1
(43) Pub. Date: Feb. 5, 2004

(54) Optical disc system using counter-rotating optical read/write assembly

(76) Inventor: Kyle Nakamura, Honolulu, HI (US)

Correspondence Address: KYLE S. NAKAMURA, 2641 PETER ST., HONOLULU, HI, 96816, US

(21) Appl. No.: 10/298,294

(22) Filed: Nov. 18, 2002

Related U.S. Application Data
(60) Provisional application No. 60/399,639, filed on Jul. 31, 2002.

(51) Int. Cl. G11B 7/135

(52) U.S. Cl. 369/112.01

(57) ABSTRACT

A disc optics system for accessing data from one or both sides of a disc is provided with an optical read/write assembly(s) that rotates in an opposite direction as the disc. The counter-rotating optical read/write assembly includes an optical head and/or an optical transport mechanism. If the optical head is not included with the counter-rotating assembly, the optical transport mechanism can be used to transport optical data to a fixed or semi-fixed optical head.

### CROSS REFERENCE TO RELATED APPLICATIONS

### U.S. Patent Documents

U.S. Pat. No. 1,858,396 May, 1932 Fey.

U.S. Pat. No. 4,527,262 July, 1985 Manto 369/33.

U.S. Pat. No. 4,567,584 January, 1986 Kawakami 369/38.

U.S. Pat. No. 4,589,101 May, 1986 Schatteman et al. 369/38.

U.S. Pat. No. 4,607,354 August, 1986 Ishibashi et al. 369/39.

U.S. Pat. No. 4,614,474 September, 1986 Sudo 414/281.

U.S. Pat. No. 4,664,454 May, 1987 Schatteman et al. 312/13.

U.S. Pat. No. 4,682,320 July, 1987 D'ALayer De Costemore D'Arc 369/77.

U.S. Pat. No. 4,701,899 October, 1987 D'Alayer De Costemore D'Arc 369/36.

U.S. Pat. No. 4,734,814 March, 1988 Fujino et al. 360/133.

U.S. Pat. No. 4,754,397 June, 1988 Varaiya et al. 364/200.

U.S. Pat. No. 4,817,070 March, 1989 Hug et al. 369/36.

U.S. Pat. No. 4,839,658 June, 1989 Honjoh 360/99.

U.S. Pat. No. 4,853,916 August, 1989 Tomita 369/36.

U.S. Pat. No. 4,855,980 August, 1989 Hug et al. 369/36.

U.S. Pat. No. 4,891,720 January, 1990 Grant et al. 360/92.

U.S. Pat. No. 4,912,575 March, 1990 Shiosaki 360/71.

U.S. Pat. No. 4,945,430 July, 1990 Konishi et al. 360/92.

U.S. Pat. No. 4,969,140 November, 1990 Koiwa et al. 369/77.

U.S. Pat. No. 4,972,396 November, 1990 Muller 369/32.

U.S. Pat. No. 4,979,160 December, 1990 Araki 369/75.

U.S. Pat. No. 4,988,038 January, 1991 Mitsuyama 229/1.

U.S. Pat. No. 5,001,582 March, 1991 Numasaki 360/98.

U.S. Pat. No. 5,020,043 May, 1991 Kohler 369/36.

U.S. Pat. No. 5,022,019 June, 1991 Motoyoshi et al. 369/36.

U.S. Pat. No. 5,036,503 July, 1991 Tomita 369/36.

U.S. Pat. No. 5,041,929 August, 1991 Fryberger et al. 360/92.

U.S. Pat. No. 5,045,958 September, 1991 Leonard et al. 360/92.

U.S. Pat. No. 5,056,077 October, 1991 Morikawa et al. 369/77.

U.S. Pat. No. 5,056,077 October, 1991 Yoshii 369/291.

U.S. Pat. No. 5,064,069 November, 1991 Su 206/425.

U.S. Pat. No. 5,067,116 November, 1991 Kadrmas 369/37.

U.S. Pat. No. 5,091,898 February, 1992 Bessho et al. 369/77.

U.S. Pat. No. 5,128,912 July, 1992 Hug et al. 369/38.

U.S. Pat. No. 5,136,562 August, 1992 Staar 369/36.

U.S. Pat. No. 5,146,451 September, 1992 Kang 369/270.

U.S. Pat. No. 5,157,646 October, 1992 Amemiya et al. 369/47.

U.S. Pat. No. 5,161,137 November, 1992 Suzuki 369/32.

U.S. Pat. No. 5,161,682 November, 1992 Seifert et al. 206/309.

U.S. Pat. No. 5,173,894 December, 1992 Kido 369/77.

U.S. Pat. No. 5,187,695 February, 1993 Schindleretal. 369/37.

U.S. Pat. No. 5,189,656 February, 1993 Masaki et al. 369/47.

U.S. Pat. No. 5,191,983 March, 1993 Hardy 211/40.

U.S. Pat. No. 5,195,066 March, 1993 Amemiya et al. 369/32.

U.S. Pat. No. 5,197,056 March, 1993 Van Heusden et al. 369/37.

U.S. Pat. No. 5,206,845 April, 1993 Baxter et al. 369/34.

U.S. Pat. No. 5,210,728 May, 1993 Noguchi et al. 369/36.

U.S. Pat. No. 5,214,628 May, 1993 Langman et al. 369/37.

U.S. Pat. No. 5,216,645 June, 1993 Sakayama 369/36.

U.S. Pat. No. 5,218,583 June, 1993 Miyajima 369/36.

U.S. Pat. No. 5,228,016 July, 1993 Menke 369/36.

U.S. Pat. No. 5,235,579 August, 1993 Ross 369/37.

U.S. Pat. No. 5,247,500 September, 1993 Miyoshi et al. 369/38.

U.S. Pat. No. 5,255,251 October, 1993 Fitzgerald et al. 369/36.

U.S. Pat. No. 5,255,255 October, 1993 Kaneda et al. 369/77.

U.S. Pat. No. 5,263,010 November, 1993 Amemiya et al. 369/47.

U.S. Pat. No. 5,267,225 November, 1993 Fukasawaet al. 369/36.

U.S. Pat. No. 5,274,620 December, 1993 Sipos 369/77.

U.S. Pat. No. 5,285,333 February, 1994 Barret al. 360/92.

U.S. Pat. No. 5,289,441 February, 1994 Domberg et al. 369/34.

U.S. Pat. No. 5,327,412 July, 1994 Lee 369/75.

U.S. Pat. No. 5,353,269 October, 1994 Kobayashi et al. 369/36.

U.S. Pat. No. 5,370,243 December, 1994 Rosario 211/40.

U.S. Pat. No. 5,373,489 December, 1994 Sato et al. 369/36.

U.S. Pat. No. 5,429,470 July, 1995 Nicol et al. 414/331.

U.S. Pat. No. 5,431,520 July, 1995 Brugger 414/277.

U.S. Pat. No. 5,446,714 August, 1995 Yoshio et al. 369/48.

U.S. Pat. No. 5,448,539 September, 1995 Kamioka 369/32.

U.S. Pat. No. 5,473,585 December, 1995 Kim 369/36.

U.S. Pat. No. 5,481,514 January, 1996 Yamasaki et al. 369/36.

U.S. Pat. No. 5,485,436 January, 1996 Forget et al. 369/36.

U.S. Pat. No. 5,488,593 January, 1996 Furumiya et al. 369/32.

U.S. Pat. No. 5,493,548 February, 1996 Kamioka 369/49.

U.S. Pat. No. 5,506,825 April, 1996 Gushima et al. 369/49.

U.S. Pat. No. 5,513,156 April, 1996 Hanaoka et al. 369/34.

U.S. Pat. No. 5,539,712 July, 1996 Menke et al. 369/36.

U.S. Pat. No. 5,544,148 August, 1996 Nakamichi 369/192.

U.S. Pat. No. 5,546,366 August, 1996 Dang 369/36.

U.S. Pat. No. 5,548,567 August, 1996 Sawai 369/36.

U.S. Pat. No. 5,561,657 October, 1996 Ogawa 369/179.

U.S. Pat. No. 5,561,658 October, 1996 Nakamichi et al. 369/263.

U.S. Pat. No. 5,576,911 November, 1996 Porter 360/98.

U.S. Pat. No. 5,610,882 March, 1997 Dang 369/36.

U.S. Pat. No. 5,613,745 March, 1997 Cho et al. 312/9.

U.S. Pat. No. 5,638,347 June, 1997 Baca et al. 369/34.

U.S. Pat. No. 5,715,948 February, 1998 Hung 211/40.

U.S. Pat. No. 5,720,386 February, 1998 Allsop et al. 206/308.

U.S. Pat. No. 5,754,508 May, 1998 Hosoda et al. 369/49.

U.S. Pat. No. 5,768,243 June, 1998 Kudo et al. 369/49.

### FOREIGN PATENT DOCUMENTS

66317B1 December, 1982 EP.

284445A1 September, 1988 EP.

288165A2 October, 1988 EP.

516496A2 December, 1992 EP.

542482A2 May, 1993 EP.

550282A2 July, 1993 EP.

589479A2 March, 1994 EP.

662687A1 July, 1995 EP.

779619A2 December, 1996 EP.

2538597A1 December, 1983 FR.

3927901A1 February, 1991 DE.

4313373A1 November, 1993 DE.

4314387A1 November, 1994 DE.

19530162A1 February, 1997 DE.

60-106250 July, 1985 JP.

62-239391 October, 1987 JP.

63-237256 October, 1988 JP.

6435758 February, 1989 JP.

166649 April, 1989 JP.

1158667 June, 1989 JP.

2244456 September, 1990 JP.

4341968 November, 1992 JP.

5234228 September, 1993 JP.

579749 October, 1993 JP.

684265A March, 1994 JP.

6195838 July, 1994 JP.

684546 December, 1994 JP.

8273268 October, 1996 JP.

955009 February, 1997 JP.

9167405 June, 1997 JP.

9167412 June, 1997 JP.

9167410 June, 1997 JP.

1028P0513 October, 1997 JP.

2286715 February, 1995 GB.

### BACKGROUND OF INVENTION

As used herein, the term CDROM are defined to include all such devices, including but not limited to, compact disc, CD-ROM, WORM, DVD, DVD-RAM, CD-WO, CD-R, CD-RW, etc. In light of some higher rewing CDROM drives, there is a physical limit of speed that some drives have faced. There are reported instances of CDs shattering from the centrifugal force applied to them by high speed CDROM drives. These instances can be attributed to discrepancies and imperfections in the CDs. Whether it is via manufactured defects or wear and tear, the result is catastrophic to both the disk and the drive. There is a solution that can solve this problem in order for CDROM drives to attempt faster access speeds beyond this threshold.

### SUMMARY OF INVENTION

This invention would use a counter rotating read/write unit. In other words, if the media rotates clockwise, the read/write assembly rotates counterclockwise. If the media rotates counterclockwise, the read/write assembly rotates clockwise.This can be accomplished in three ways.

1. Counter-rotate the laser and pickup assembly (FIG. 1).

2. Counter-rotate a reflecting/refracting device (mirror/prism) to redirect light signals to a fixed laser and pickup assembly (FIG. 2 and FIG. 2-1).

3. Counter-rotate an inner housing, which would include the laser and pickup assembly (FIG. 3).

### BRIEF DESCRIPTION OF DRAWINGS

FIG. 1 illustrates the method of Counter-rotating the laser and pickup assembly.

FIG. 2 illustrates the method of Counter-rotating a reflecting/refracting device (mirror/prism) to redirect light signals to a fixed laser and pickup assembly.

FIG. 2-1 illustrates the method of Counter-rotating a reflecting/refracting device (mirror/prism) with a fixed radius to redirect light signals to a fixed laser and pickup assembly.

FIG. 3 illustrates the method of Counter-rotating an inner housing, which would include the laser and pickup assembly.

### DETAILED DESCRIPTION

Counter-rotation would allow the disk to stay at a limiting RPM (revolutions per minute) that would be within the tolerance of current media and yet allow read speeds well beyond that threshold. The counter-rotation of the read/write device will be multiple for the access time. As an example, if the read/write device rotates counter-clockwise at 10,000 RPM and the disk rotates clockwise at 10,000 RPM, the opportunity to read/write would occur 20,000 times a minute or twice the speed of a conventional design at 10,000 times a minute. For simplicity, I used this example, however I envision this concept as having the read/write device spinning at a fraction of the disk speed. Although, I would not doubt technology and ingenuity could accomplish this eventually.

This single biggest hurdle for these designs, as in most, is the law of physics. This obstacle is the conservation of centrifugal force. If the weight of an object(read/write device, mirror/prism, housing, etc.) moves closer to the center of rotation, it will tend to spin faster. Alternately, if the weight moves farther from the center of rotation, it will tend to spin slower. This problem can be overcome by counter weights, software or both. In a counter weight solution, a device would extend in and out inversely to the read/write device/mirror/prism. This means if the read/write device/mirror/prism moves in, the counter weight will move out. If the read/write device/mirror/prism moves out, the counter weight will move in. This would counter any tendencies for speeding up or slowing down. The other solution is a software solution. The read/write function will accommodate for slower and faster reads and write speeds depending on the location of the read/write device/mirror/prism. This will obviously affect performance. Reads and writes near the center of the disk will be ultra fast compared to the outer disk.

Counter-rotating the laser and pickup assembly would involve mounting the laser and pickup assembly on a rotating platform. This platform will allow the laser and pickup assembly to move in and out while rotating in the opposite direction of the spinning media.

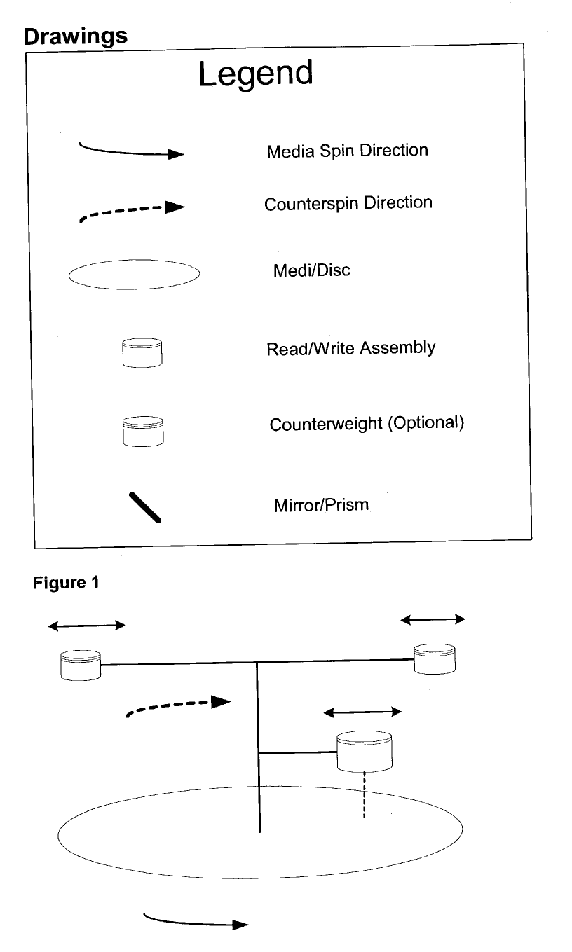

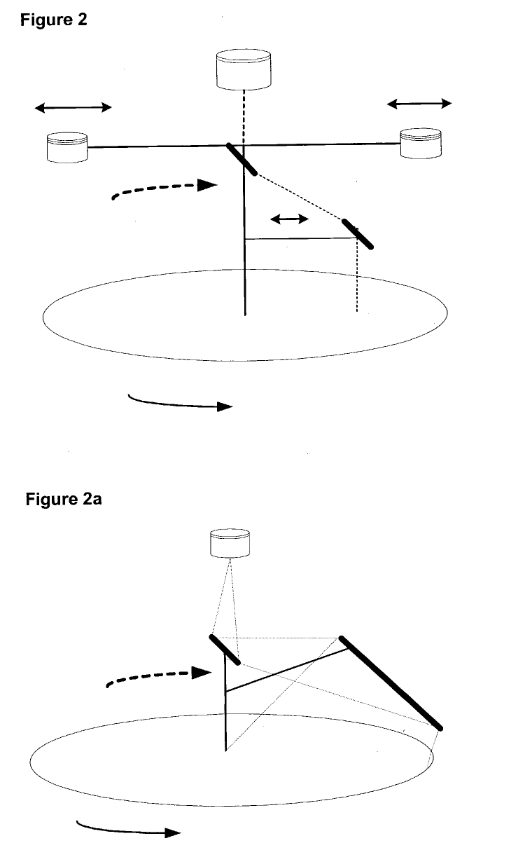

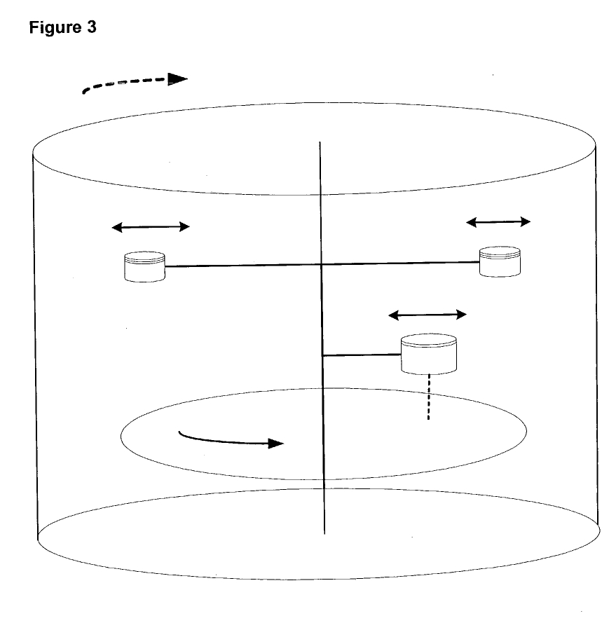

Counter-rotating a reflecting/refracting device (mirror/prism) to redirect light signals would involve a reflecting or a refracting device mounted on a rotating platform that would bounce or bend the light to and from laser mounted in a fixed point. The major hurdle would be the fact the as the mirror/prism is rotated and moved in and out, the angle of reflection/refraction is changed dramatically. This can be overcome by three ways or a combination of all. Mechanically change the direction of the mirror/prism, use fiber optics or other data transport media to capture/transmit the light to and from central location, or use a large enough mirror/prism/transport mechanism that allows a counter-spinning device with a fixed radius with the head movement solely left to fixed laser or read/write head (FIG. 2-1).

Counter-rotating an inner housing, which would include the laser and pickup assembly is a method where the entire drive unit consists of an outer housing and an inner housing. The outer housing will remain fixed, as this is the framework in which the assembly is mounted to a PC (Personal Computer) bay. The inner housing will contain the laser and pickup assembly and disk platform. This entire inner housing will counter rotate with the disk.

Of all these designs, Counter-rotate a reflecting/refracting device (mirror/prism) to redirect light signals to a fixed laser and pickup assembly (FIG. 2-1) is the most feasible, requiring less research and development resources. In this design, the Reflection/Refraction/Data transport rotates at a fixed radius. It will remove the conservation of centrifugal forces from the equation. This will also allow much faster rotational speeds with less moving parts. The Laser/Pickup Assembly, Read/Write Head pivots to access every cylinder/track. Significant gains in speed can be relatively easily achieved using this design.

In the foregoing specification, the invention has been described with reference to specific embodiments thereof. It will however be evident that various modifications and changes can be made thereto without departing from the broader spirit and scope of the invention as set forth in the appended claims. Thus, the particular combination of parts described and illustrated herein is intended to represent only a few embodiments of the present invention, and is not intended to serve as limitations of alternative devices.

What is claimed is:

1. A disc optics system for accessing data from a disc, the disc optics system comprising an assembly that is counter-rotated opposite of the direction of the disc.
a. The assembly includes a positioning arm and/or rails with an optical read/write head.
b. The assembly also includes other devices that assist in the function accessing data such as a counter-weight assembly to counteract centrifugal forces applied to the said counter-rotating assembly and a data transport assembly that assist in reflecting and/or refracting optical data transmissions.
c. Defining a disc as one or more flat, circular, disk-shaped media for storing an index (Table of Contents data) and data. Disc is used indistinguishably with disk.
d. Defining an optical read/write head as comprising of a laser diode, focusing lens, reflecting mirror, photo-detector, prisms, housing and fixtures.

2. A disc optics system for accessing data from a disc, the disc optics system comprising an assembly that is counter-rotated opposite of the direction of the disc.
a. The assembly includes a positioning arm and/or rails with a data transport assembly that assists in reflecting and/or refracting optical data transmissions to a fixed or semi-fixed optical read/write head.
